(19) United States
(12) Patent Application Publication
(10) Pub. No.: US 2011/0270977 A1
(43) Pub. Date: Nov. 3, 2011

(54) ADAPTATION SYSTEM FOR LAWFUL INTERCEPTION WITHIN DIFFERENT TELECOMMUNICATION NETWORKS

(76) Inventors: Arnaud Ansiaux, Nozay (FR); Emmanuel Onfroy, Colombes (FR)

(21) Appl. No.: 13/139,853

(22) PCT Filed: Dec. 14, 2009
(86) PCT No.: PCT/FR09/52513

§ 371 Date: Jul. 18, 2011

(30) Foreign Application Priority Data
Dec. 18, 2008 (FR) 0858773

(51) Int. Cl. G06F 15/173

(52) U.S. Cl. 709/224

(57) ABSTRACT

A lawful interception architecture for an operator of communication networks (NWO) comprising sets of interception probes (SON₁-SON_{N}) respectively deployed in telecommunication networks (RT₁-RN_{N}) in order to provide envelope data (DonE) and content data (DonC) regarding communications passing through at east one of the telecommunication networks, comprising an adaptation system (SA) which receives envelope data and content data provided by at least one set of interception probes (SONₙ), and converts the envelope data into formatted envelope data (DonF) of a single predetermined format. The system associates this formatted envelope data and this content data with one another, the formatted envelope data containing a single identifier (IDC) for the associated content data and being saved within a data saving device (DRD) connected to the system.

The present invention concerns a system for concatenating lawful interception information about a single individual and related to different means of communication used by the individual.

Currently, authorities, for example government authorities, that wish to obtain lawful interception information about an individual, known as a “target”, draw upon the listening to and retrieval of information related to a given means of communication used by the individual.

However, of said target may use different means of communication related to different telecommunications operators and service providers, and based on different technologies, such as data networks like the Internet or wired or wireless networks using various communication protocols.

The authorities must use different interception probes specific to the different means of communication used by the individual in order to obtain lawful interception information about the individual, but do not have a comprehensive and harmonized view of the legal interception capacities via the different means of communication.

There is therefore need to concatenate and merge lawful interception information about a single individual derived from different interception probes specific to different means of communication used by the individual.

An objective of the invention is to remedy the aforementioned drawbacks by proposing a system for managing and administering information probes in order to improve the effectiveness of a lawful interception architecture, and particularly to facilitate and accelerate the processing of intercepted data, in order to assist in decision-making

To achieve this objective, a system to be used within a lawful interception architecture of a communications network operator comprising sets of interception probes respectively deployed within telecommunications networks in order to provide envelope data and content data related to communications over a east one of the telecommunications networks, is characterized in that it comprises:

means for receiving envelope data and content data respectively provided by sets of interception probes and for converting the envelope data provided by each of the sets of interception probes into formatted envelope data in a single, unified predetermined format, and

means for associating the formatted envelope data with the content data that is provided by each of the sets of interception probes, the formatted envelope data containing an identifier of the associated content data and being saved within a data saving device connected to the system.

The system adapts exchanges between heterogenous probes of different telecommunications networks, as well as between platforms for mediating and saving data of the legal interception architecture. The system additionally has a modular architecture which is capable of quickly integrating new interception probe technologies.

Advantageously, the operator defines a single format for the data to be saved and stored within the data saving device. Owing to this single format, the choice of a database for the data saving device, which is very costly for the operator, is independent of the specific features of the interception probes. Furthermore, the invention offers the ability to integrate new interception probes based on interception systems already deployed, without needing to edit or change the database of the data saving device.

According to another characteristic of the invention, the system may further comprise means for determining probes which are active among the sets of interception probes, prior to this set providing envelope data and content data. The system may further comprise means for determining the available resources of probes which are active, i.e. the operational status of these probes.

Advantageously, the invention provides authorities a comprehensive view of the different interception probes capable of being used for a given request, depending on the activity status and availability of the probes.

The invention also relates to a lawful interception method for a lawful interception architecture of a communications network operator comprising sets of interception probes respectively deployed within telecommunications networks to provide envelope data and content data related to communications over at east one of the telecommunications networks, characterized in that it comprises the following steps within a system included in the lawful interception architecture:

receiving envelope data and content data respectively provided by sets of interception probes and converting the envelope data provided by each of the sets of interception probes into formatted envelope data in a single, unified predetermined format,

associating the formatted envelope data with the content data that is provided by each of the sets of interception probes, the formatted envelope data containing an identifier of the associated content data, and

transmitting the formatted envelope data to a data saving device that is connected to the system and which saves the formatted envelope data.

The present invention and the benefits thereof shall be better understood upon examining the description below, which makes reference to the attached figures, in which:

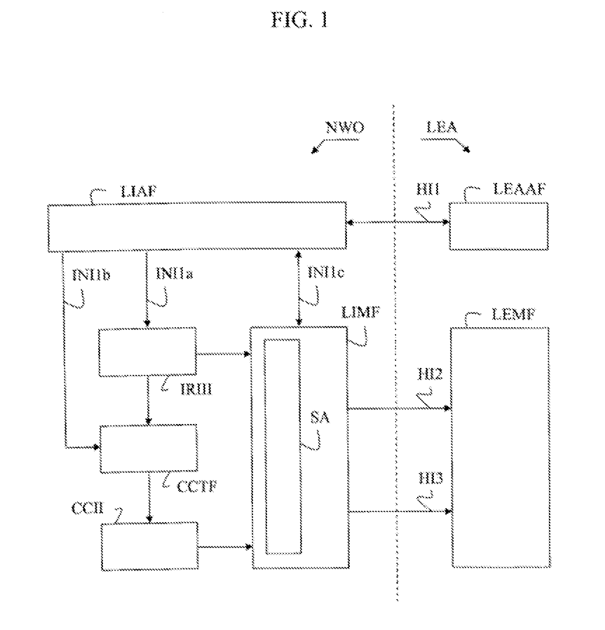

FIG. 1 is a schematic block diagram of a lawful interception architecture according to the ETSI standard, including an adaptation system according to the invention;

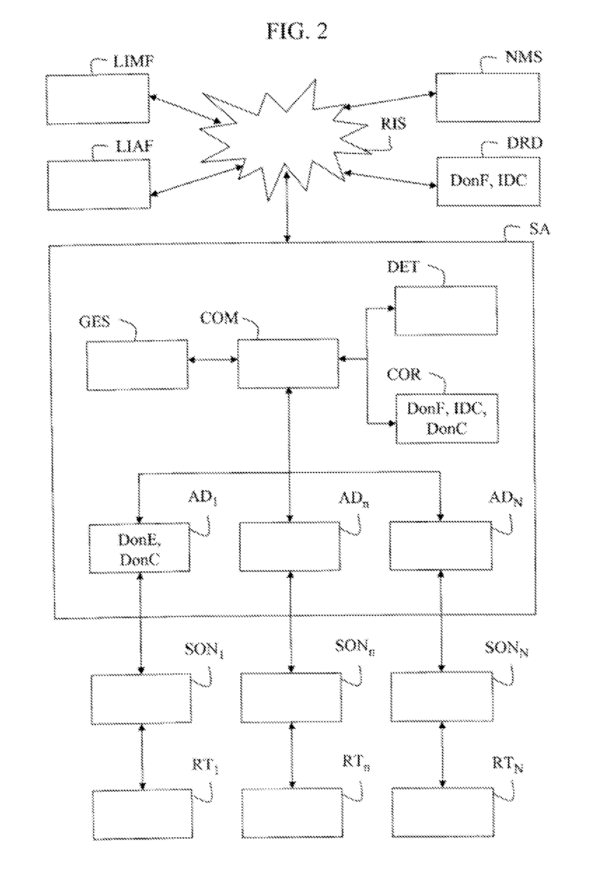

FIG. 2 is a schematic block diagram of an adaptation system within a telecommunications network according to the invention, and

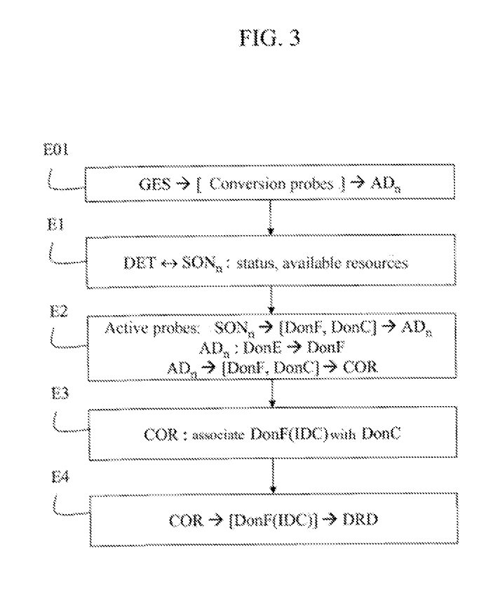

FIG. 3 is an algorithm of a lawful interception method according to the invention.

With reference to FIG. 1, a lawful interception architecture comprises a law enforcement agency domain LEA and at least one communications network operator domain NWO.

Each domain comprises modules that may be defined by sets of hardware and/or software implementing the program instructions.

The domain of the agency LEA, managed by authorities, such as government authorities, comprises an administration module LEAAF (“LEA Administration Function”) and a monitoring module LEMF (“Law Enforcement Monitoring Facility”).

The domain of the operator NWO comprises an administration module LIAF (“Lawful Interception Administration Function”), a mediation module LIMF (“Lawful Interception Mediation Function”), a trigger module CCTF (“Content of Communication Trigger Function”), and interception modules IRIII (“Intercept Related Information Internal Interception”) and CCII (“Content of Communication Internal Interception”). The administration module LIAF communicates with the interception module IRIII, the trigger module CCTF and the mediation module LIMF respectively via des internal interlaces INI1a, INI1b and INI1c (“Internal Network Interface”).

In the administration modules LIAF and LEAAF communicate with one another via an external interface HI1 (“Handover Interface”) and the monitoring module LEMF and mediation module LIMF communicate with one another via external interfaces HI2 and HI3.

According to one embodiment of the invention, an adaptation system SA is included within the mediation module LIMF of the operator's domain NWO, in order to be in direct interaction with the interception modules IRIII and CCII.

With reference to FIG. 2, an adaptation system SA according to one embodiment of the invention comprises an adapter manager GES, a communication module COM, a module for determining probes' statuses DET, a correlation module COR, and sets of adapters AD₁ to AD_{N}.

The adaptation system SA is connected via a secure internal network RIS to which are connected the mediation module LIMF, the administration module LIAF, a network management system NMS and a data saving device DRD.

The role of the network management system NMS is to manage the operation of the equipment of the operator's various telecommunications networks.

The role of the data saving device DRD is to save and store, within a database, technical telecommunications information about the communications that the operator may lawfully save, such as the type of communication (voice, message), the numbers that form part of the communication, and the starting time and length of a communication. This information may be linked to information about the customers of the telecommunications network's operator that this operator possesses, such as the subscription contract or user profile.

The communication module COM serves as an interlace with the sets of adapters AD₁ to AD_{N}, the different modules of the operator's domain NWO and particularly with the network management system NMS and the data-saving device DRD.

The communication module COM also communicates with the adapter manager GES, the module for determining the status of probes DET and the correlation module COR of the adaptation system SA.

The communication module COM may be linked to a human-machine interface that is controlled by a system administrator.

The sets of adapters AD₁ to AD_{N} are respectively connected to net of probes SON₁ in SON_{N} which are respectively deployed within telecommunications networks RT₁ to RT_{N}.

The telecommunications networks RTₙ, where 1≦n≦N. are managed by the communication network operator and may be networks of different types connected to one another. By way of example, a telecommunications network RTₙ may be a digital cellular radio communications network that is a GSM (“Global System for Mobile communications”) or UMTS (“Universal Mobile Telecommunications System”) network, or a WiFi (“Wireless Fidelity”) or WiMAX (“Worldwide Interoperability for Microwave Access”) wireless network. A telecommunications network RTₙ may be a wired network, such as an ISDN (Integrated Services Digital Network) landline telephone network supporting, for example, IP protocol (“Internet Protocol”). A telecommunications network RTₙ may also be an NGN (“Next Generation Network”) or IMS (“IP Multimedia Subsystem”) network.

Each set of probes SONₙ, where 1≦n≦N. comprises one or more probes that can listen to and capture communications data transmitted within the telecommunications network RTₙ. For example, within a telecommunications network RTₙ offering voice over IP network services, probes embedded within routers are listening to data going into and/or coming from media and application servers. A probe may be a specific an independent piece of equipment devoted only to listening to and capturing data. A probe may also be included within a piece of network equipment, i.e. such a piece of network equipment may have software and hardware features adapted to listening to and capturing traffic data.

In particular, each probe is capable of capturing data DonC known as “content” data corresponding to data representative of the communications content established within the telecommunications network. Each probe is also capable of capturing data DonE known as “envelope” data corresponding to technical information about the communications established within the telecommunications network that the operator may lawfully save and restore, such as the type of communication (voice, message), the numbers that form part of the communication, or the start and end dates of a communication.

Each probe uses a protocol specific to the telecommunications network, and more particularly specific to the manufacturer of the probe, in order to transfer captured traffic data to the lawful interception architecture. Thus, probes manufactured by different manufacturers may have different methods for listening and capturing, and provide content and envelope data in formats specific to the probes.

Each set of adapters ADₙ, where 1≦n≦N. converts the envelope data DonE intercepted by the corresponding set of probes SONₙ into formatted envelope data DonF that is interpretable by the correlation module COR and the data saving device DRD. All of the sets of adapters ADₙ thereby provide formatted envelope data DonF which is in a single, unified format.

In order to automatically convert the envelope data DonE intercepted by the set of probes SONₙ, the corresponding set of adapters ADₙ uses conversion rules previously transmitted by the adapter manager GES. This manager transmits to each set of adapters ADₙ conversion rules adapted to the specific technical features of the set of probes SONₙ connected to the set of adapters ADₙ.

The formatted envelope data DonF is intended to be saved and stored within the data saving device DRD, while the content data DonC may be directly transmitted to authorities who ordered a lawful interception operation and might not be saved within the device DRD.

The correlation module COR performs a correlation between the formatted envelope data DonF and the content data DonC saved by each of the sets of adapters ADₙ in order to associate the formatted envelope data DonF and the content data DonC. For example, if multiple probes are used to simultaneously to provide data DonF and DonC, each probe may transmit a probe identifier to the correlation module COR so that this module can distinguish the origins of the various data DonF and DonC. The formatted envelope data DonF is then saved within the data saving device DRD while the content data DonC is transmitted to the authorities, Optionally, the content data DonC is also saved within the data saving device DRD as a match for the formatted envelope data DonF.

The formatted envelope data DonF contains identifier IDC which safely and uniquely designates the associated content data DonC. If no lawful interception order was given by the authorities, the probes only capture the envelope data and the data retention device saves formatted envelope data that does not contain the content data identifier IDC.

According to one example, the content data identifier IDC may be an information field within the formatted envelope data DonF which is blank when no lawful interception order was given by the authorities, or which is filled by a unique reference of the content data DonC whenever a lawful interception order has been given by the authorities.

The content data identifier IDC thereby makes it possible to establish a match between the formatted envelope data DonF and the content data DonC provided by a single probe. Thus, if the authorities who received the content data DonC wish to obtain additional information about the communications related to this content data DonC, the authorities may request from the operator the formatted envelope data DonF stored in the data saving device DRD corresponding to the content data DonC. The operator then quickly locates the desired formatted envelope data DonF by means of the content data identifier IDC.

All of the formatted envelope data DonF is in the same, unified format, which facilitates the management of this data within the data saving device DRD.

The adaptation system SA, included within or directly connected to the mediation module LIMF of the domain of the operator NWO, thereby performs a prior process of adaptation and correlation on the content and envelope data coming from interception probes deployed within the various telecommunications networks before the content data is processed in-depth by the authorities.

The probe status determination module DET queries, via the sets of adapters ADₙ, probes deployed in the various telecommunications networks, which, in response, transmit to the module DET information about their activity status and their real-time interception capabilities. The sets of adapters ADₙ can use the conventional probe administration interfaces to determine the probes' operational statuses. Each queried probe transmits information to the module DET indicating whether the probe is active or inactive, and if the probe is active, information indicating the probe's current usage load. The module DET is thereby informed of the probe's available resources in order to perform a lawful interception operation. For example, if 80% of a probe's total resources are already occupied, the probe, though active, might not be capable of performing a lawful interception operation.

The querying of the probes by the module DET may be periodic and regular, for example every second or every minute. In this situation, the module DET saves the information transmitted by the probes in a database, and updates this database each time other information is received. The probes may also be queried by the module DET on special request by the module DET, for example following a lawful interception order transmitted by the authorities.

Optionally, each probe transmits information on its location within the telecommunications network and on its various lawful interception features, if the probe status determination module DET did not have this information beforehand.

The probe status determination module DET provides the network management system NMS with real-time information on the activity status and availability of the interception probes deployed in the various telecommunications networks.

According to one embodiment of the invention, the adaptation system SA enhances the features of the management system NMS by transmitting it information in real time about the intersection capabilities of the intersection probes. A system administrator, via a human-machine interface, may immediately obtain a comprehensive view of the interception capabilities related to a predetermined target, in order to launch lawful interception commands to selected probes.

With reference to FIG. 3, a lawful interception method according to one embodiment of the invention comprises steps E1 to E4 automatically executed within the lawful interception architecture according to the invention.

In a preliminary step E01, the adapter manager GES transmits to each set of adapters ADₙ conversion rules adapted to the specific technical features of the set of probes SONₙ connected to the set of adapters ADₙ. Each set of adapters ADₙ is also capable of dialoguing with the corresponding set of probes SONₙ. For example, each set of adapters ADₙ comprises command scripts for querying the set of probes SONₙ regarding these lawful interception features in a language that may be interpreted by the set of probes SONₙ.

During step E1, following a lawful interception order given by the authorities, regarding communications to be listened to involving a targeted person or targeted communication equipment, the probe status determination module DET determines the probes which are active among the probes deployed within the various telecommunications networks and capable of meeting the needs specified within the lawful interception order. The module DET also determines available resources of the active probes in order to perform a lawful interception operation.

For example, a system administrator, via a human-machine interface, queries the probe status determination module DET in order to immediately obtain a comprehensive view of active probes capable of performing lawful interception operations related to a target predetermined in the lawful interception order.

During step E2, the active probes of each set of probes SONₙ are commanded to respectively provide to the corresponding set of adapters ADₙ envelope data DonE and content data DonC related to the communication specified in the lawful interception order. Optionally, only the active probes that have available resources beyond a predetermined threshold provided DonE and DonC data. Each set of adapters ADₙ receives envelope data DonE and converts this data into formatted envelope data DonF in a single, unified format. Each set of adapters ADₙ transmits the formatted envelope data DonF and the content data DonC in the correlation module COR.

During step E3, the correlation module COR associates the formatted envelope data DonF with the content data DonC provided for each of the sets of adapters ADₙ, by including within the formatted output data DonF an identifier IDC uniquely designating the associated content data DonC.

During step E4, the correlation module COR provides formatted envelope data DonF and the content data DonC for the lawful interception architecture, in particular, the correlation module COR may directly transmit the formatted envelope data DonF to the data saving device DRD which saves them, and transmits the content data DonC to the authorities.

Later, the operator is capable of retrieving formatted envelope data DonF associated with content data DonC with the assistance of the content data identifier IDC saved within the data saving device DRD.

1. A system to be used within a lawful interception architecture of a communications network operator comprising sets of interception probes respectively deployed within telecommunications networks to provide envelope data and content data related to communications over at least one of the telecommunications networks, comprising:
means for receiving envelope data and content data respectively provided by sets of interception probes and for converting the envelope data provided by each of the sets of interception probes into formatted envelope data in a single, unified predetermined format, and
means for associating the formatted envelope data with the content data that is provided by each of the sets of interception probes, the formatted envelope data containing an identifier of the associated content data and being saved within a data saving device connected to the system.

2. The system according to claim 1, wherein the format of the formatted envelope date is the only format compatible with the data saving device.

3. The system according to claim 1, wherein the envelope data is converted into the formatted envelope data as a function of predefined conversion rules.

4. The system according to claim 1, further comprising means for determining probes which are active among the sets of interception probes prior to this set providing envelope data and content data.

5. The system according to claim 4, further comprising means for determining the available resources of probes which are active.

6. The system according to claim 4, wherein only the active probes provide envelope data and content data.

7. A lawful interception method for a lawful interception architecture of a communications network operator comprising sets of interception probes respectively deployed within telecommunications networks to provide envelope data and content data related to communications over at least one of the telecommunications networks, the method comprising the steps of:
receiving envelope data and content data respectively provided by sets of interception probes and converting the envelope data provided by each of the sets of interception probes into formatted envelope data in a single, unified predetermined format,
associating the formatted envelope data with the content data that is provided by each of the sets of interception probes, the formatted envelope data containing an identifier of the associated content data, and
transmitting the formatted envelope data to a data saving device that is connected to the system, the data saving device being configured to save the formatted envelope data.
